(19) United States
(12) Patent Application Publication
(10) Pub. No.: US 2009/0135449 A1
(43) Pub. Date: May 28, 2009

(54) IMAGE FORMING APPARATUS

(75) Inventors: Takeshi Watanabe, Yokohama-shi (JP); Nobuhiko Nakahara, Susono-shi (JP); Shigeru Fujiwara, Yokohama-shi (JP); Hiroyuki Okuyama, Hiratsuka-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/277,452

(22) Filed: Nov. 25, 2008

Related U.S. Application Data
(60) Provisional application No. 60/990,393, filed on Nov. 27, 2007.

(51) Int. Cl. H04N 1/60

(52) U.S. Cl. 358/3.01

(57) ABSTRACT

An image forming apparatus includes a pattern formation unit which forms a first gradation screen pattern on an image carrier unit at a non-image formation operation, a gradation characteristic determination unit which determines a gradation characteristic from the first gradation pattern formed by the pattern formation unit, a first gradation correction characteristic determination unit which determines a first gradation correction characteristic from the gradation characteristic determined by the gradation characteristic determination unit, a characteristic detection unit which detects a change characteristic in the image forming apparatus just before image formation, a pattern correlation characteristic correction unit which determines a pattern correlation characteristic corresponding to the change characteristic detected by the characteristic detection unit and a second gradation correction characteristic determination unit which determines a second gradation correction characteristic by performing an arithmetic operation on the first gradation correction characteristic and the pattern correlation characteristic.

### CROSS-REFERENCE TO RELATED APPLICATION

This application claims the benefit of U.S. Provisional Application No. 60/990,393, filed Nov. 27, 2007.

### TECHNICAL FIELD

The present invention relates to an image quality adjustment method for an image forming apparatus, and particularly to a gradation correction technique.

### BACKGROUND

In recent years, as a color image forming apparatus becomes widespread, a demand for high image quality is increased. In the color image forming apparatus of electrophotographic system, in general, toners of four colors of Y (Yellow), M (Magenta), C (Cyan) and K (Black) are superimposed, so that a full-color image is represented. Thus, when the gradation of each of the toners of the four colors is shifted even slightly, the color shade of a final image is much changed. That is, it is important to keep the gradation property constant against temporal change due to the use of the image forming apparatus or environmental change. Thus, various image quality maintaining controls for keeping the gradation property are studied.

In JP-A-2000-238341, an image forming apparatus prints a specific pattern such as a gradation pattern on a print member such as paper, and reads the printed image by a scanner as a document reading device. Then, the image forming apparatus creates a correction table from the read image information, and records the correction table after a desired gradation characteristic can be obtained seemingly. At almost the same time as that, the image forming apparatus forms a specific pattern such as a gradation pattern on a photoconductive drum under the same process potential condition as the above, reads it by a photosensor or the like, and records it as reference density on the photoconductive drum into a record unit. After the image forming apparatus is used for a while or is left as it is (for example, when the power source of the image forming apparatus is turned ON), instead of remaking the correction table by again printing the pattern on a paper, the image forming apparatus forms the specific pattern such as the gradation pattern on the photoconductive drum, and reads it by the photosensor or the like. The image forming apparatus compares the density read by the photosensor with the reference density recorded in the record unit, and determines a correction amount to the correction table determined when printing is performed on the paper. A method is proposed in which a feedback is made to the image forming apparatus based on the determined correction amount.

Here, with respect to the gradation pattern periodically printed on the photoconductive drum and detected by the photosensor, when the kind is made the same as the pattern used in the printing operation, the number of gradations is increased and many patches are printed, high gradation accuracy can be expected.

However, actually, since an adjustment time becomes long, the number of patches is limited. Thus, with respect to an intermediate gradation, a mathematical interpolation process or the like is performed and an estimate is made.

Besides, each time the screen pattern of image printing is changed, when the gradation pattern is printed on the photoreceptor just before the change and an adjustment is made, the productivity is remarkably decreased. Thus, in general, the adjustment is performed at print intervals of several hundred to several thousand sheets, or is often performed when the power source is turned ON or when the print operation is ended. That is, the number of kinds of the patch patterns is 1 to 2, and actually, the correction characteristics of many kinds of print patterns must be estimated.

Here, when the gradation characteristic of another kind of screen is estimated from the gradation characteristic of the specific screen pattern, in general, the correlation between the screen patterns is represented by, for example, the concept of a function, and the respective conversion tables are previously recorded in the apparatus.

Alternatively, many kinds of screen patterns are printed on paper, and when they are read by a scanner, a conversion table is obtained by calculation and is recorded in the image forming apparatus, and differently from that, a gradation patch in a specific screen pattern is formed on the photoreceptor. Then, the reflectivity and density thereof are detected by the photosensor. The gradation correction characteristic is determined with respect to the specific pattern, and after the correction is performed by applying it, the function of the pattern correlation is applied. Thus, the gradation correction can be continuously performed also in the other kind of pattern without printing on paper and reading by the scanner each time.

However, actually, the function of the pattern correlation is changed by change in environmental condition and material characteristic, and as a result, there is a problem that when a patch pattern printed on an image carrier unit is different from a pattern printed on paper, high accuracy can not be necessarily maintained.

As described above, there is a problem that when the screen pattern of the patch formed on the image carrier unit and read by the photosensor is different from the screen pattern actually printed on the paper, the accuracy can not be necessarily maintained, and the most serious cause thereof is as follows. That is, the correlation is lost since the characteristic of a developer is changed in a developing unit, or the characteristic of the photoreceptor is changed.

Accordingly, the present invention provides an image forming apparatus in which a pattern correlation function can be appropriately corrected.

### SUMMARY

According to one aspect of the present invention, there is provided an image forming apparatus comprising: an image carrier unit which forms a developer image; a pattern formation unit which forms a first gradation screen pattern on the image carrier unit at a non-image formation operation; a gradation characteristic determination unit which determines a gradation characteristic from the first gradation pattern formed by the pattern formation unit; a first gradation correction characteristic determination unit which determines a first gradation correction characteristic from the gradation characteristic determined by the gradation characteristic determination unit; a characteristic detection unit which detects a change characteristic in the image forming apparatus just before image formation; a pattern correlation characteristic correction unit which determines a pattern correlation characteristic corresponding to the change characteristic detected by the characteristic detection unit; a second gradation correction characteristic determination unit which determines a second gradation correction characteristic by performing an arithmetic operation on the first gradation correction characteristic and the pattern correlation characteristic; and a control unit to form an image based on the second gradation correction characteristic.

### DESCRIPTION OF THE DRAWINGS

FIG. 1 is a schematic view showing an outer appearance of an image forming apparatus to which a toner cartridge of an embodiment is applied.

FIG. 2 is a schematic view showing an inner structure of the image forming apparatus of the embodiment seen from the front side.

FIG. 3 is a block diagram showing a control system of the image forming apparatus of the embodiment.

FIG. 4 is a flowchart of image quality maintaining control in the embodiment.

FIG. 5 is a conceptual view of gradation correction in the embodiment.

FIG. 6 shows actually measured data of correlation characteristics of different screen patterns in the embodiment.

FIG. 7 is a graph showing a shift amount of a pattern correlation function in the embodiment.

FIG. 8 is a graph showing a shift function obtained from a shift of a first pattern correlation function corresponding to a characteristic change of a development bias value in the embodiment.

FIG. 9 is a graph showing a shift intensity function to determine the intensity of a shift function in the embodiment.

FIG. 10 is a graph showing a shift amount of a first pattern correlation function corresponding to a characteristic change of a photoconductive drum in the embodiment.

FIG. 11 is a graph showing a shift function obtained from the shift of the first pattern correlation function corresponding to the characteristic change of the photoconductive drum in the embodiment.

FIG. 12 is a graph showing a shift intensity function to determine the intensity of a shift function in the embodiment.

FIG. 13 is a graph showing a shift amount of the first pattern correlation function corresponding a humidity change in the embodiment.

FIG. 14 is a graph showing a shift function obtained from the shift of the first pattern correlation function corresponding to the humidity change in the embodiment.

FIG. 15 is a graph showing an intensity function to determine the intensity of a shift function in the embodiment.

FIG. 16 is a graph showing experimental results of a case where image quality maintaining correction in the embodiment is applied and a case where it is not applied.

FIG. 17 is a graph showing experimental results of a case where the image quality maintaining correction in the embodiment is applied and a case where it is not applied.

### DETAILED DESCRIPTION

Hereinafter, embodiments will be described.

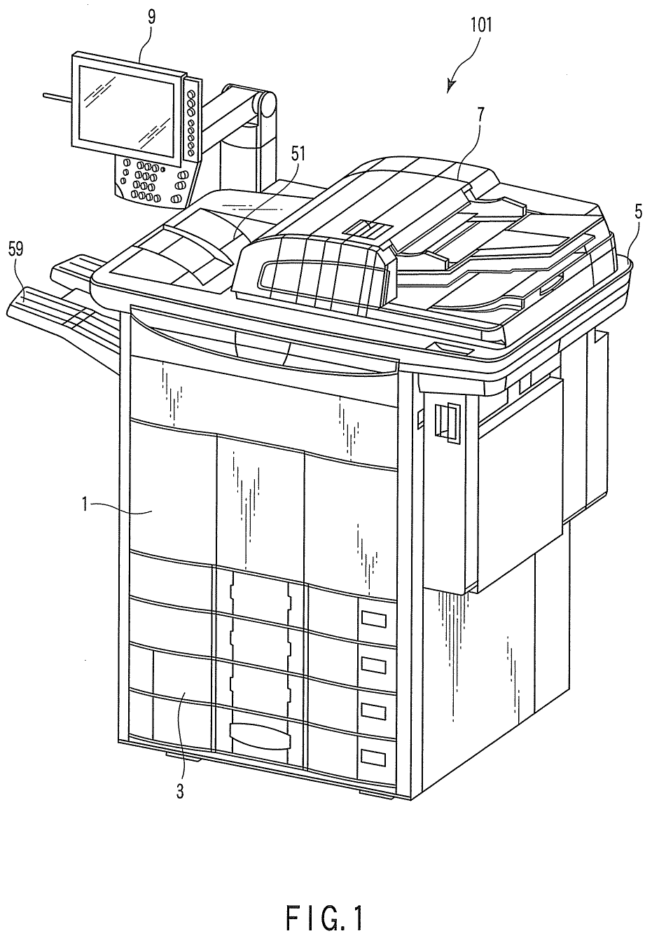

FIG. 1 is a perspective view showing an outer appearance of an image forming apparatus 101 of an embodiment. The image forming apparatus 101 is a four-tandem color copier. The image forming apparatus 1 includes an image forming unit 1 to output image information as an output image called, for example, a hard copy or a printout, a sheet feeding unit 3 to feed a sheet (output medium) of an arbitrary size used for image output to the image forming unit 1, and a scanner (image reading unit) 5 to capture the image information as an object of image formation in the image forming unit 1 as image data from an object (hereinafter referred to as an original document) holding the image information. Incidentally, an auto document feeder 7 is provided above the image forming unit 1, in which when the original document is sheet-like, after the end of reading of image information in the image reading unit 5, the original document after the end of reading is ejected from the reading position to an eject position, and a next original document is guided to the reading position. Besides, the image forming apparatus 101 is provided with an instruction input unit to instruct a start of image formation in the image forming unit 1 or a start of reading of the image information of the original document by the image reading unit 5, that is, a display unit 9 as a control panel.

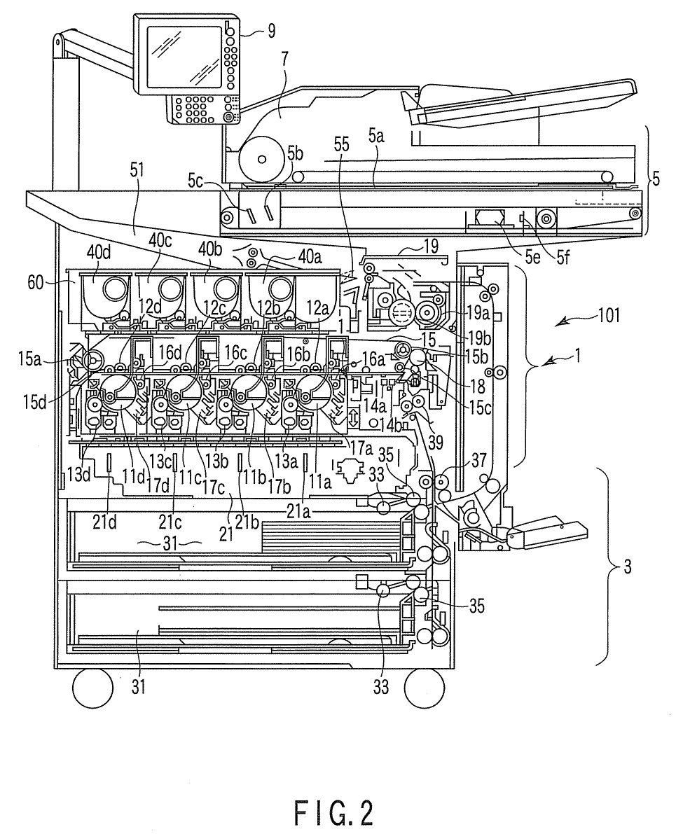

FIG. 2 is a schematic view showing an inner structure of the image forming apparatus 101 seen from the front side. First, the structure of the image reading unit 5 will be described. The image reading unit 5 includes a transparent platen 5a on which an original document is placed, an optical source 5b to illuminate the original document, and a reflecting mirror 5c to reflect a light reflected from the original document. The light source 5b and the reflecting mirror 5c are integrally provided in an original document illumination unit 5d movable in the horizontal direction. The reflected light by the original document illumination unit 5d is received by a CCD 5f through an imaging lens 5e disposed on an optical path.

Next, the structure of the image forming unit 1 will be described. Toner cartridges 40a, 40b, 40c and 40d are provided in parallel at an upper side of the image forming unit 1. The toner cartridges 40a, 40b, 40c and 40d are attachable to and detachable from a cartridge holding mechanism 60 provided at the front side of the image forming unit 1. The toner cartridges 40a, 40b, 40c and 40d are for supplying toners of yellow, magenta, cyan and black.

The image forming unit 1 includes first to fourth photoconductive drums 11a to 11d as image carrier units to hold latent images, developing devices 13a to 13d to develop the latent images formed on the photoconductive drums 11a to 11d, an intermediate transfer belt 15 to hold developer images developed on the photoconductive drums 11a to 11d in a stacked state, cleaners 16a to 16d to remove toners remaining on the photoconductive drums 11a to 11d from the respective photoconductive drums 11a to 11d, and chargers 17a to 17d to uniformly charge the photoconductive drums 11a to 11d.

The image forming unit 1 includes a transfer device 18 to transfer the developer images stacked on the intermediate transfer belt 15 to a sheet-like output medium such as a general standard paper which is not subjected to a specific process or an OHP sheet which is a transparent resin sheet, and a fixing device 19 to fix the developer images transferred to the transfer target medium to the output medium. Besides, the image forming unit 1 includes an exposure device 21 formed of LDs 21a to 21d to irradiate the photoconductive drums 11a to 11d with laser beams modulated according to writing image data and to form latent images.

The intermediate transfer belt 15 is stretched by a drive roller 15a to rotate the intermediate transfer belt 15, a tension roller 15b to cause tensile force applied to the intermediate transfer belt 15a to become constant, and a backup roller 15c for secondary transfer.

At places (primary transfer units) where the intermediate transfer belt 15 contacts with the photoconductive drums 11a to 11d, primary transfer rollers 12a to 12d are respectively disposed at the back side of the intermediate transfer belt 15a to come in press contact with the photoconductive drums 11a to 11d through the intermediate transfer belt 15.

The transfer device 18 (secondary transfer unit) is disposed at the toner carrying surface side (outside) of the intermediate transfer belt 15 to come in contact with the intermediate transfer belt 15, and is opposite to a backup roller 15c disposed at the back side (inside) of the intermediate transfer belt 15. The backup roller 15c has an opposite electrode to the transfer device 18.

At a place of the intermediate transfer belt 15 where the drive roller 15a is provided and at a position opposite to the drive roller 15a through the intermediate transfer belt 15, a belt cleaner 15d is disposed to be in contact with the intermediate transfer belt 15.

An LED light source 14a and an optical sensor 14b for detecting the amount of reflected light of a toner patch pattern formed on the intermediate transfer belt 15 are disposed between a fourth station of the primary transfer unit and the secondary transfer unit.

The first to the fourth photoconductive drums 11a to 11d respectively hold electrostatic images (latent images) of colors to be visualized (developed) by the developing devices 13a to 13d containing toners of arbitrary colors of Y (yellow), M (magenta), C (cyan) and Bk (black), and the order of arrangement thereof is regulated in a specified order according to an image formation process and the characteristic of the toner (developer). The intermediate transfer belt 15 holds the developer images of the respective colors formed by the first to the fourth photoconductive drums 11a to 11d and the corresponding developing devices 13a to 13d in the order of formation of the developer images.

When the transfer device 18 transfers the developer image, the sheet feeding unit 3 feeds the output medium to the transfer device 18 at a specified timing.

Cassettes set in plural cassette slots 31 contain output media of arbitrary sizes. The pickup roller 33 takes out the output medium according to the image formation operation. The size of the output medium corresponds to the size of the developer image formed by the image forming unit 1. A separation mechanism 35 prevents two or more output media from being taken out by the pickup roller 33 from the cassette. Plural conveyance rollers 37 convey the output medium the number of which is limited to one by the separation mechanism 35 to an aligning roller 39. The aligning roller 39 sends the output medium to the transfer position where the transfer device 18 contacts with the intermediate transfer belt 15 in synchronization with the timing when the transfer device 18 transfers the developer image from the intermediate transfer belt 15. Incidentally, as the need arises, plural cassette slots 31, plural pickup rollers 33 and plural separation mechanisms 35 are prepared, and the cassette can be arbitrarily mounted to a different slot.

The output medium on which the image information is fixed through the fixing device 19 is ejected to a paper ejection tray 51 defined on the side of the image reading unit 5 and above the image forming unit 1. Here, the fixing device 19 includes a fixing roller 19a and a pressure roller 19d at the downstream side in the paper eject direction. On the output medium to which the developer image is transferred, the developer image is fused by the fixing roller 19a whose temperature is raised up to 180° C. and the pressure roller, and the image information is fixed.

Besides, the image forming apparatus 101 includes a side paper ejection tray 59 at the side surface of the image forming unit 1. The output medium discharged from the fixing device 19 is guided to the side paper ejection tray 59 through a relay conveyance unit 71 connected to a switching unit 55.

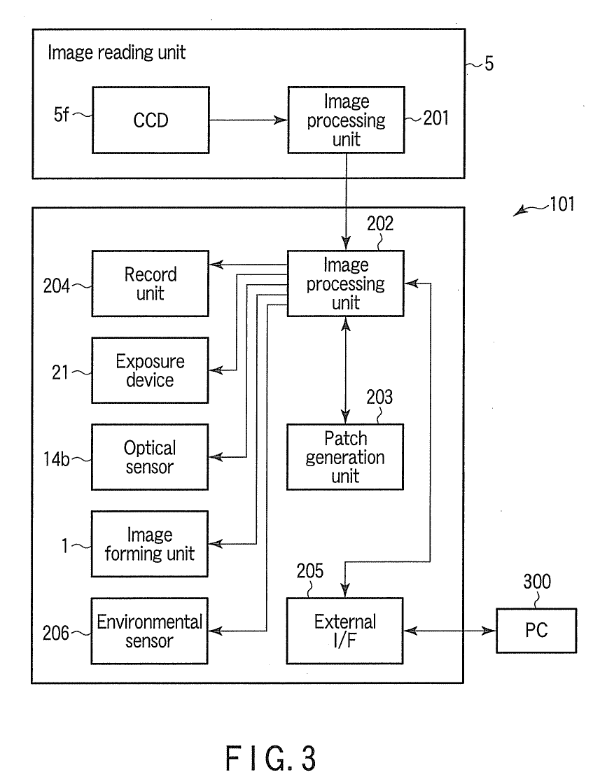

FIG. 3 is a block diagram showing a control system of the image forming apparatus 101 of the embodiment. An image processing unit 201 is provided at the side of the image reading unit 5. The image processing unit 201 converts the output signal from the reflected light received by the CCD 5f into image data of yellow (Y), magenta (M), cyan (C) and black (K), performs data processing such as density correction, and outputs writing image data.

The image forming unit 1 includes a control unit 202, a patch generation unit 203, and a record unit 204. The control unit 202 controls the LDs 21a to 21d of the exposure device 21 to irradiate the photoconductive drums 11a to 11d with the laser beams modulated according to the writing image data by the image processing unit 201. Besides, the control unit 202 acquires the amount of reflected light of the patch pattern detected by the optical sensor 14b such as a photodiode, and detects the toner density. The patch generation unit 203 generates the patch pattern transferred to the intermediate transfer belt 15. The record unit 204 records various information described later.

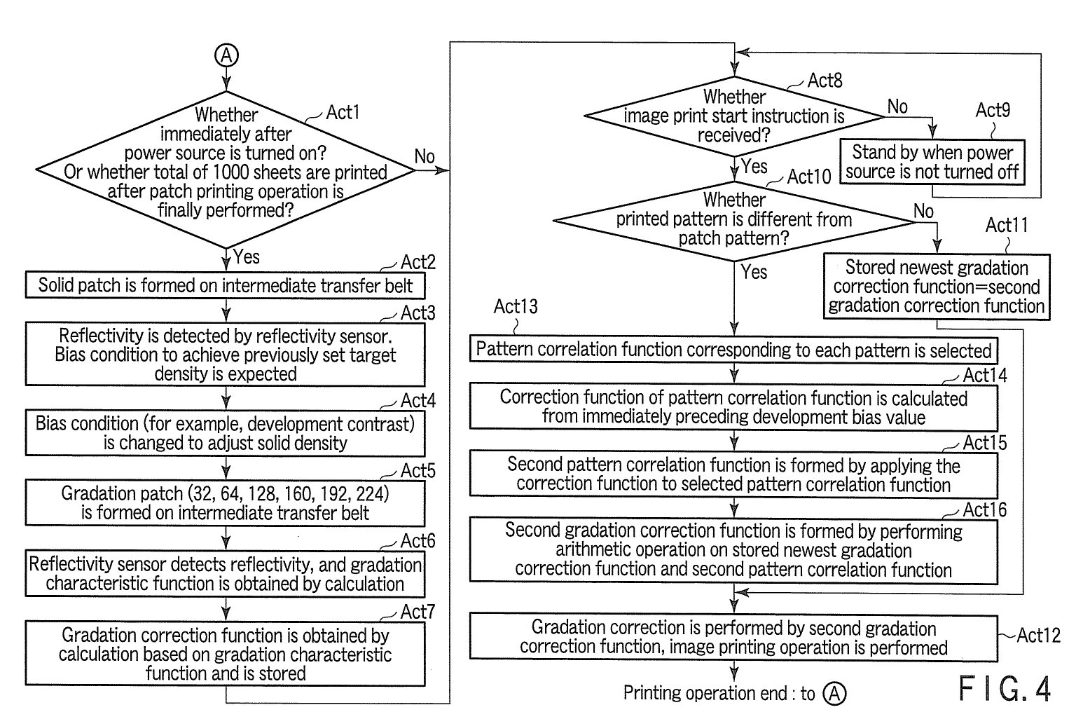

Next, image quality maintaining control of the embodiment will be described with reference to a flowchart shown in FIG. 4.

First, immediately after the power source of the image forming apparatus 101 is turned ON, in accordance with a previously determined condition, for example, after a total of 1000 or more sheets are printed since the image quality maintaining control was performed, or after a specified time passes, the control unit 202 determines whether the readjustment of the gradation characteristic is necessary (Act 1). When the control unit 202 determines that the readjustment of the gradation characteristic is necessary (Act 1, YES), the control unit 202 controls so that a solid patch or a high density patch is formed on the intermediate transfer belt 15, and performs the image quality maintaining control to adjust the solid density.

The control unit 202 supplies the solid patch pattern to the exposure device 21. The exposure device 21 forms latent images of the solid patch pattern on the photoconductive drums 11a to 11d (Act 12). The developing devices 13a to 13d develop the latent images. Developed images are formed on the surfaces of the photoconductive drums 11a to 11d. The developed images are transferred to the intermediate transfer belt 15.

Next, the control unit 202 detects the reflectivity of the solid patch pattern transferred to the intermediate transfer belt 15 by the optical sensor 14b, and converts the reflectivity into density (Act 3). The control unit 202 detects a shift from a previously set target density, and changes the image formation condition from that and performs setting so that the solid density becomes identical to the target density.

The change of the image formation condition to the target density can be realized such that the control unit 202 changes the developing bias values applied between the developing devices 13a to 13d and the photoconductive drums 11a to 11d and the charge potentials charged to the photoconductive drums 11a to 11d by the chargers 17a to 17d while keeping the same potential difference, and changes the development contrast potential to adjust the solid density. As the adjustment method of the solid density, according to the shift of the solid density of the solid patch pattern from the target density, the control unit 202 may apply the correction amount of the development bias value and the charging bias value previously recorded as a table in the record unit 204. After correcting the development bias value and the charging bias value, the control unit 202 again prints the solid patch pattern or the high density patch pattern to detect the solid density, and may again perform a similar correction control in reaction to the result.

In an experiment, the target density value of the solid density is set to 1.5, and the signal (reference value) of the optical sensor 14b is adjusted so that the solid density of the solid patch pattern formed on the intermediate transfer belt 15 has a value of 1.5±0.02, which is obtained by the optical sensor 14b made by Macbeth Corporation.

Next, in the state where the solid density becomes the target density value, the control unit 202 controls so that as a first gradation screen pattern, a halftone gradation patch pattern is formed on the intermediate transfer belt 15 (Act 5). The control unit 202 reads, for example, seven patch patterns corresponding to gradation levels of 32/255, 64/255, 96/255, 128/255, 160/255, 192/255 and 224/255 by a dot screen with 160 lines from the record unit 204, and forms them on the intermediate transfer belt 15. The control unit 202 detects the reflectivity of the gradation patch pattern at each gradation level by the optical sensor 14b (Act 6).

The relation between the reflectivity detected by the optical sensor 14b and the gradation value of the final image to the output medium may be previously recorded in the record unit 204. Besides, the image reading unit 5 reads the gradation patch pattern printed on a sheet, and the control unit 202 uses a separately printed gradation patch pattern, and may record the relation in the record unit 204.

As stated above, the control unit 202 obtains the gradation characteristic table of the dot screen with 160 lines or the gradation characteristic function from the reflectivity detected by the optical sensor 14b.

The control unit 202 performs an arithmetic operation on the gradation characteristic table or the gradation characteristic function to obtain a first gradation correction table or a first gradation correction function for correcting a shift from a previously set gradation (usually linear to an input) (Act 7). The control unit 202 records the gradation correction table or the gradation correction function obtained by the arithmetic operation into the record unit 204.

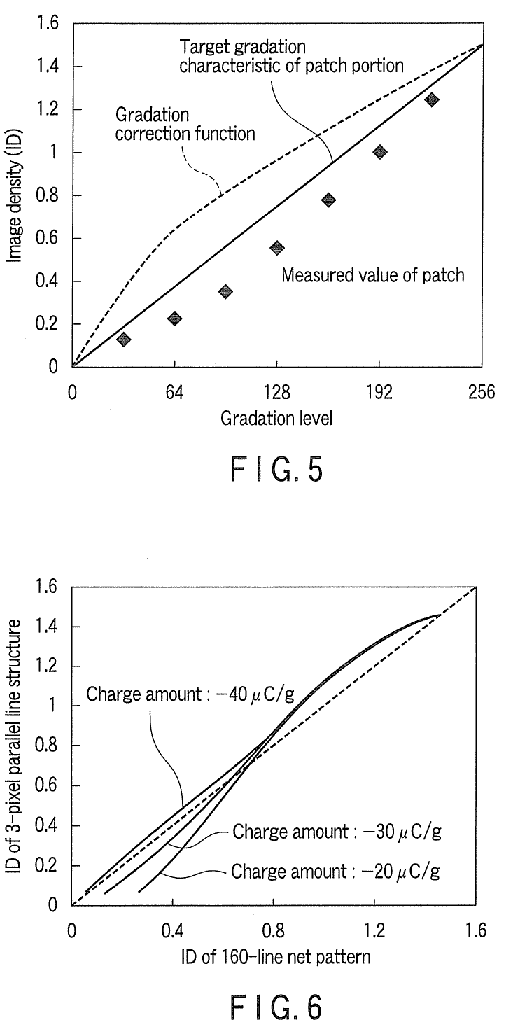

Here, FIG. 5 is a conceptual view of the gradation correction described above. The horizontal axis represents gradation level, and the vertical axis represents image density. The vertical axis may represent the value normalized by a so-called image density value of 1.5.

When the control unit 202 does not detect the input of an image print start instruction (Act 8, No), the image forming apparatus 101 is placed in a standby state (Act 9).

When determining that the image print start signal is inputted from a PC 300 as an external equipment through an external interface 205 (Act 8, YES), the control unit 202 determines whether the image print start signal (second gradation screen pattern) is the same screen pattern as the patch pattern (first screen pattern) (Act 10).

When the control unit 202 determines that the image print start signal is the same screen pattern as the patch pattern (Act 10, NO), as described above, the first gradation correction function obtained by the gradation correction shown in FIG. 5 and recorded in the record unit 204 is acquired as a gradation correction function (here, called a second gradation correction function for convenience) as it is (Act 11).

The control unit 202 uses the second gradation correction function (=first gradation correction function) to perform the gradation correction, and performs an image printing operation on an output medium (Act 12).

When determining that the image print start signal is a screen pattern different from the patch pattern (Act 10, YES), the control unit 202 selects a first pattern correlation function of the screen pattern printed on the output medium and the patch pattern formed on the intermediate transfer belt 15 (Act 13).

Here, in the record unit 204, the first pattern correlation function corresponding to the dot screen with 160 lines, which is the patch pattern, and each of screen patterns, such as a binary error diffusion pattern used in the print mode for actual printing on the output medium, a dot screen with 190 lines, and a parallel line structure pattern in units of three pixels of 600 dpi, is previously recorded. For example, the image reading unit 5 reads the screen patterns printed on the sheet, and the control unit 202 obtains gradations of the respective screen patterns and may record them in the record unit 204.

For example, when the screen pattern of the image print start signal is the three-pixel parallel line structure pattern of 600 dpi, at Act 13, the control unit 202 reads the first pattern correlation function (P(x)) of the three-pixel parallel line structure pattern and the patch pattern of the dot screen with 160 lines, which is previously recorded in the record unit 204.

Here, when the first pattern correlation function between the screen pattern of the image print start signal and the patch pattern is always constant, when the first pattern correlation function is added to the gradation correction in the case where the screen pattern of the image print start signal and the patch pattern are equal to each other, correction can be performed with high accuracy. However, actually, the first pattern correlation function is not always constant.

First, correction using development contrast potential will be described. The correction using the development contrast potential is a useful method for detecting the development characteristic. When the average charge amount of toner is low, the contrast becomes low, and when the average charge amount is high, the contrast becomes high. Here, the development contrast potential can be expected by the development bias value and the exposure amount of the exposure device 21. Strictly speaking, the photoreceptor characteristics of the photoconductive drums 11a to 11d must be considered, however, when the exposure amount of the exposure device 21 is set to be twice or more of the half exposure amount of the photoconductive drums 11a to 11d, irrespective of the change of the exposure amount, the change amount of the development contrast potential becomes almost equal to the development bias value. On the other hand, when the exposure amount of the exposure device 21 is set to be twice or more of the half exposure amount of the photoconductive drums 11a to 11d, the development contrast potential receives an influence of not only the development bias value but also the change of the exposure amount. However, when the exposure amount is not much changed, the development contrast potential can be roughly expected by the development bias value.

FIG. 6 shows actually measured data of correlation characteristics of the three-pixel parallel line structure pattern and the dot screen with 160 lines in the respective cases where the average charge amount of toner is −20 μC/g, −30 μC/g, and −40 μC/g. The average charge amount of toner is measured and obtained by sampling of toner provided in the developing devices 13a to 13d. Here, the average charge amount of toner is measured by E-SPART ANALYZER made by Hosokawa Micron Corporation. The horizontal axis of the graph represents the gradation of the 160-line screen, and the vertical axis represents the three-pixel parallel line structure pattern. When the proportional relation of Y=X is established, it can be said that the correlation between the three-pixel parallel line structure pattern and the 160-line screen is 1:1 and the same. However, it is clear that the correlation between the three-pixel parallel line structure pattern and the 160-line screen is not 1:1. It is understood that when the toner charge amount is changed, the correlation function itself clearly varies. Especially, in an area (low density portion) where the gradation is low, the shift is large.

Here, for example, the ratio of toner to carrier unit in the developing devices 13a to 13d is intentionally changed to form toner of different charge amount, and the development bias value can be adjusted so that the maximum density (Max ID) becomes 1.5. The development bias value of the developer having the standard ratio of toner to carrier unit is −300V. In the developer in which the toner density is lower than the standard, since the charge amount of the toner becomes high, the development bias value is raised. Conversely, in the developer in which the toner density is higher than the standard, the development bias value is reduced. Here, the developers in which the optimum development bias values become −240V, −270V, −300V, −330V and −360V are prepared, and the pattern corrections at that time are compared.

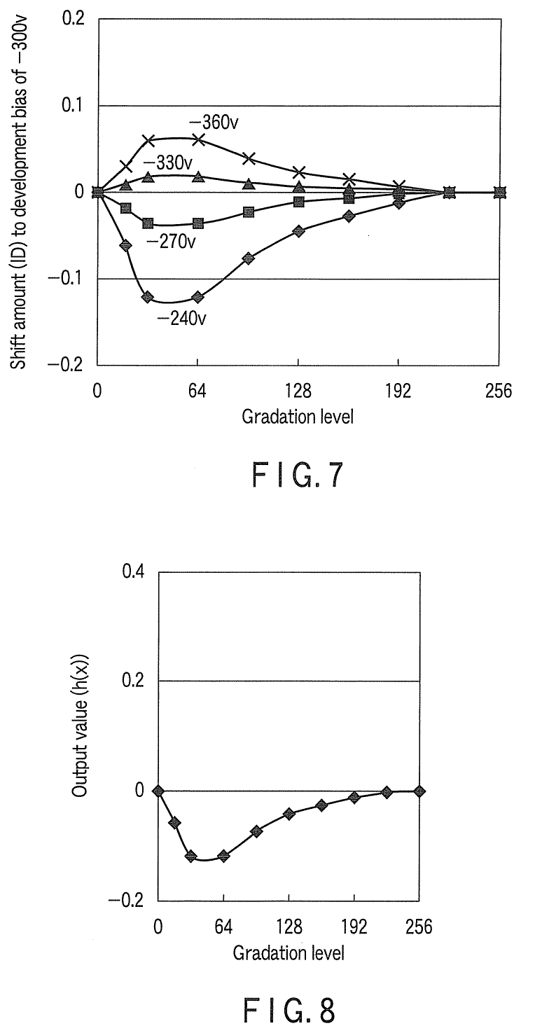

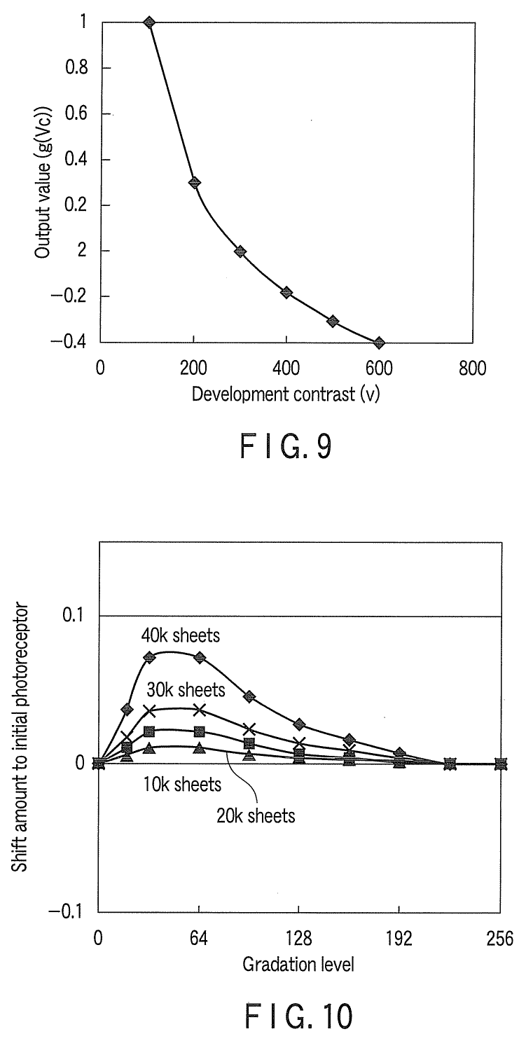

FIG. 7 is a graph in which the horizontal axis represents the gradation value and the vertical axis represents the shift amount of the first pattern correlation function when the development bias value is changed while the first pattern correlation function at the standard development bias value is made a reference (zero). As is understood from FIG. 7, with respect to the reference value (zero) in which the development bias value is −300V, the shape of the shift amount of the first pattern correlation function corresponding to the development bias value has roughly the same tendency (similar shape) as the shift amount of the development bias value from the standard value (−300V). That is, the control unit 202 can obtain a shift intensity function to determine the intensity of a shift function for each screen pattern of the image print start signal by the shift function in the patch pattern of each screen pattern of the image print start signal and the shift amount from the standard value of the development bias value. The shift intensity function can sufficiently represent the shift amount of the first pattern correlation function. FIG. 8 shows a shift function (h(x)) obtained from the shift of the first pattern correlation function in this result of study. FIG. 9 shows a shift intensity function (g(Vc)) to determine the intensity of a shift function.

The control unit 202 performs an arithmetic operation on the shift function (h(x)) and the shift intensity function (g(Vc)) and obtains (h(x)·g(Vc)) (Act 14). (h(x)·(Vc)) is defined as a correction function by development bias.

Then, the control unit 202 applies the correction function to the pattern correlation function (P(x)) and forms a second pattern correlation function (P(x)·h(x)·g(Vc)) (Act 15).

Next, the control unit 202 performs an arithmetic operation on the newest first gradation correction function recorded in the record unit 204 and the second pattern correlation function (P(x)·h(x)·g(Vc)) and forms the second gradation correction function (Act 16). The control unit 202 uses the second gradation correction function to perform gradation correction, and performs an image printing operation on the output medium (Act 12).

Next, an embodiment will be described in which a pattern correlation function is corrected from the use history of the photoconductive drums 11a to 11d and the toner. Although this embodiment is basically the same as the foregoing embodiment, the first pattern correlation function is corrected based on, for example, the integrated number of printed sheets by the photoconductive drums 11a to 11d, not the development bias value.

FIG. 10 is a graph in which the horizontal axis represents the gradation value and the vertical axis represents the shift amount of a correlation function when the integrated number of printed sheets by the photoconductive drums 11a to 11d increases while the pattern correlation function in the initial state of the photoconductive drums 11a to 11d is made a reference (zero).

From this, similarly to the correction by the detection of the development contrast potential described in the above embodiment, even if the integrated number of printed sheets increases from the reference value (zero) in the initial state of the photoconductive drums 11a to 11d, the shape of the graph of the shift amount has roughly the same tendency. That is, the control unit 202 can obtain a shift intensity function for determining the intensity of a shift function for each screen pattern of an image print start signal from the shift function in the patch pattern of each screen pattern of the image print start signal and the shift amount of the integrated number of printed sheets by the photoconductive drums 11a to 11d from the initial value. It is understood that the shift intensity function can sufficiently represent the shift amount of the first pattern correlation function.

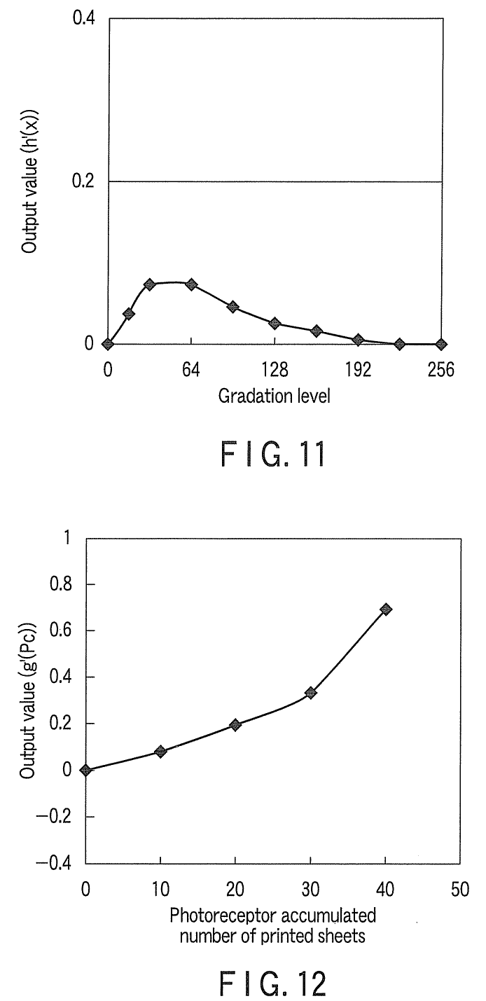

FIG. 11 shows a shift function (h′(x)) obtained from the pattern shift in this case. FIG. 12 shows a shift intensity function (g′(Pc)) to determine the intensity of the shift function.

The control unit 202 performs an arithmetic operation on the shift function (h′(x)) and the shift intensity function (g′(Pc)) to obtain (h′(x)·g′(Pc)). (h′(x)·g′(Pc)) is defined as a correction function by the use history of the integrated number of printed sheets by the photoconductive drums 11a to 11d.

Next, a method of correcting a pattern correlation function from a detection signal by an environmental sensor 206 provided in the image forming apparatus 101 will be described.

The electrophotographic process provided in the image forming apparatus 101 as in the embodiment is changed by an environment in the image forming apparatus 101. In this embodiment, a value detected by an environmental sensor 206 provided in the image forming apparatus 101 is used. Although the control unit 204 may detect both temperature and humidity by the environmental sensor 206 and may correct them, here, a method of detecting the humidity and using it will be described.

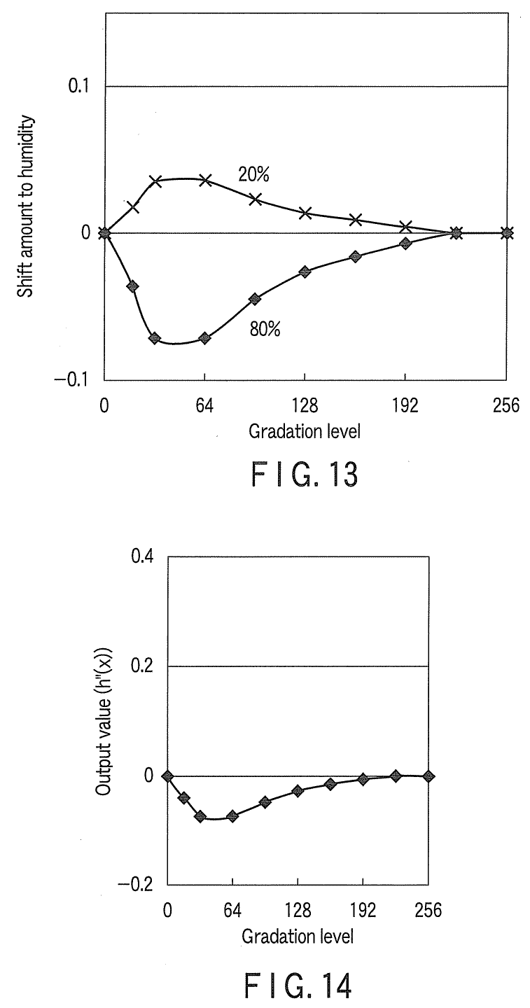

FIG. 13 is a graph in which the horizontal axis represents the gradation value and the vertical axis represents the shift amount of a first pattern correlation function when humidity is changed while the first pattern correlation function at a humidity of 50% is made a reference (zero). According to this, similarly to the correction by the detection of the development contrast potential described in the above embodiment, when the humidity is changed from the reference value (zero), the shift amount is relatively shifted, however, the shape of the graph has roughly the same tendency.

That is, the control unit 202 can obtain a shift intensity function to determine the intensity of a shift function for each screen pattern of an image print start signal by the shift function in the patch pattern of each screen pattern of the image print start signal and the shift amount from the initial value at the humidity of 50%. The shift intensity function can sufficiently represent the shift amount of the correlation function.

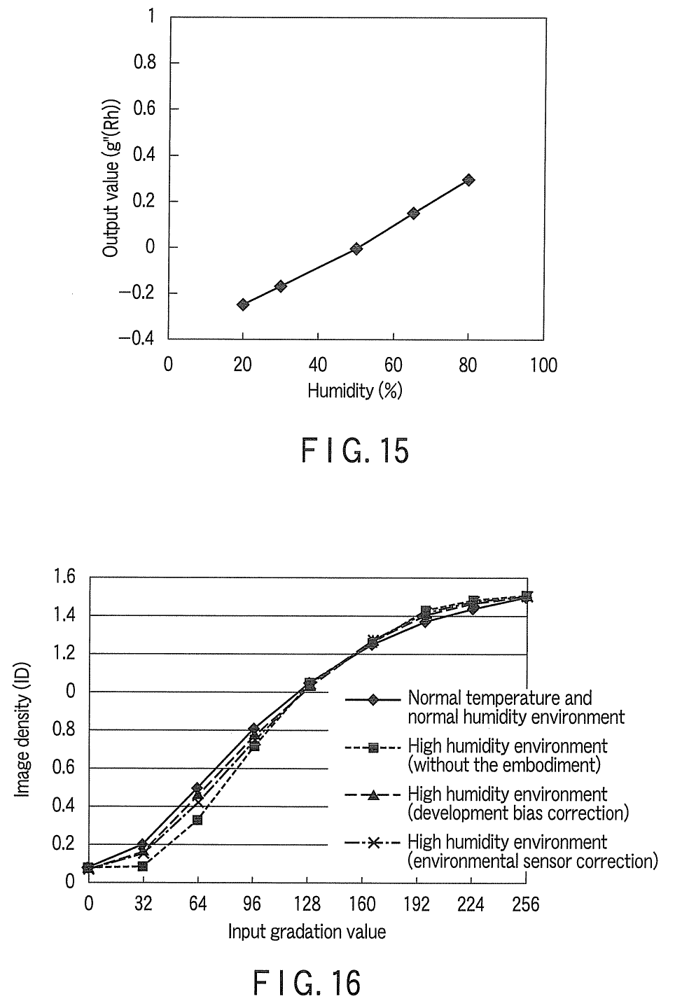

FIG. 14 shows a shift function (h″(x)) in this case. FIG. 15 shows a shift intensity function (g″(Rh)) to determine the intensity of the shift function. (h″(x)·g″(Rh)) obtained by the arithmetic operation of these is defined as a correction function by humidity change.

FIG. 16 shows actual experimental results of a case where the image quality maintaining correction of this embodiment is applied and a case where it is not applied. When the photoconductive drums 11a to 11d and the developer are in the initial state, patch patterns at seven points are printed on the intermediate transfer belt 15 by a screen pattern with 160 lines. FIG. 16 shows comparison results of actual images printed on an output medium by a second gradation correction function and by a three-pixel parallel line structure pattern.

FIG. 16 shows gradation characteristics in a normal temperature and normal humidity environment, in a high humidity environment in which this embodiment is not applied, in a high humidity environment in which the development contrast correction of this embodiment is applied, and in a high humidity environment in which the environment sensor correction of this embodiment is applied, while the horizontal axis represents input gradation value, and the vertical axis represents image density. When the four gradation characteristics are compared, in the result in which the image quality maintaining correction is performed in the normal temperature and normal humidity environment (temperature of 21° C., and humidity of 50%), and the result in which the image quality maintaining correction of the embodiment is performed in the high temperature and high humidity environment (temperature of 30° C., humidity of 80%), unless the image quality maintaining correction of the embodiment is applied, the gradation characteristic is shifted. Besides, the shift is decreased in both the case where the development contrast correction of this embodiment is performed, and the case where the environment sensor correction is performed from the humidity sensor value.

In the experiments performed at this time, since the temperature is also considerably changed, the gradation characteristic obtained by the development contrast correction has higher accuracy than that obtained by the environment sensor correction. However, when the correction function is optimized in view of the temperature as well, the performance is improved a little more. On the other hand, the image quality maintaining correction method by the development contrast correction is very effective since high accuracy can be expected from the viewpoint of control and the cost in the case where the sensor is provided.

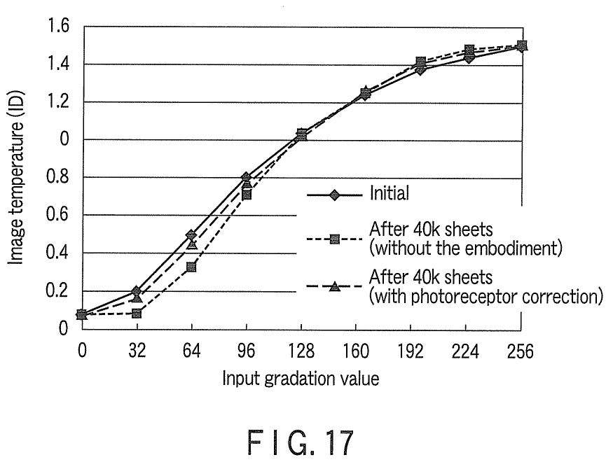

FIG. 17 shows actual experimental results of the case where the image quality maintaining correction of the embodiment is applied and the case where it is not applied. The results are obtained in the case where the photoconductive drums 11a to 11d are in the initial state and the case where the correction in the embodiment is applied to the photoconductive drums 11a to 11d after 40 k sheets are printed. It is understood that the shift amount from the initial state can be made small by applying the embodiment. In these corrections, it is not necessary that only one kind of correction is performed, and it is easily expected that for example, when the development contrast correction and the correction based on the integrated number of printed sheets of the photoconductive drums 11a to 11d are combined, the accuracy becomes higher. When higher accuracy is targeted, it is desirable to suitably combine them.

In the embodiment, when the environment in the image forming apparatus 101 or the material characteristic is changed, even if an image different from the patch pattern for image quality maintenance is printed, since the pattern correlation function is corrected based on the signal of the environment sensor to detect the environmental change, the image quality maintaining operation can be performed with high accuracy. That is, plural patch patterns are not required, and the control time is shortened. When the image quality pattern is changed, even if the image quality maintaining operation is not performed each time, the high accuracy and stable gradation characteristic can be maintained, and the highly stable image can be provided in a short time.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
an image carrier unit which forms a developer image;
a pattern formation unit which forms a first gradation screen pattern on the image carrier unit at a non-image formation operation;
a gradation characteristic determination unit which determines a gradation characteristic from the first gradation pattern formed by the pattern formation unit;
a first gradation correction characteristic determination unit which determines a first gradation correction characteristic from the gradation characteristic determined by the gradation characteristic determination unit;
a characteristic detection unit which detects a change characteristic in the image forming apparatus just before image formation;
a pattern correlation characteristic correction unit which determines a pattern correlation characteristic corresponding to the change characteristic detected by the characteristic detection unit;
a second gradation correction characteristic determination unit which determines a second gradation correction characteristic by performing an arithmetic operation on the first gradation correction characteristic and the pattern correlation characteristic; and
a control unit to form an image based on the second gradation correction characteristic.

2. The apparatus of claim 1, wherein:
the pattern correlation characteristic correction unit determines the pattern correlation characteristic based on a reference pattern correlation characteristic obtained by correlating the first gradation screen pattern with a second gradation screen pattern at the image formation.

3. The apparatus of claim 2, wherein:
the pattern correlation characteristic correction unit uses the reference pattern correlation characteristic corresponding to the second gradation screen pattern.

4. The apparatus of claim 1, wherein:
when the first gradation screen pattern is equal to the second gradation screen pattern, the control unit forms the image based on the first gradation correction function.

5. The apparatus of claim 1, comprising:
a record unit which records the first pattern correlation characteristic.

6. The apparatus of claim 1, wherein:
the characteristic detection unit detects a development bias value as the change characteristic.

7. The apparatus of claim 1, wherein:
the characteristic detection unit detects the number of printed sheets as the change characteristic.

8. The apparatus of claim 1, wherein:
the characteristic detection unit detects humidity as the change characteristic.

9. The apparatus of claim 2, wherein:
the pattern correlation characteristic correction unit corrects the reference pattern correlation characteristic based on a function indicating a shift amount of the reference pattern correlation characteristic with respect to a gradation level.

10. The apparatus of claim 9, wherein:
the pattern correlation characteristic correction unit corrects the reference pattern correlation characteristic based on a correction function obtained by performing an arithmetic operation on the function indicating the shift amount and a function to determine intensity of the function indicating the shift amount with respect to the change characteristic.

11. The apparatus of claim 1, comprising:
a detection unit which irradiates a light to the first gradation pattern formed by the pattern formation unit and detects a reflected light,
wherein the gradation characteristic determination unit determines the gradation characteristic from the reflected light detected by the detection unit.

12. An image forming method comprising:
forming a first gradation screen pattern at a non-image formation operation on an image carrier unit on which a developer image is formed;
determining a gradation characteristic from the first gradation pattern;
determining a first gradation correction characteristic from the gradation characteristic;
detecting a change characteristic in an image forming apparatus just before image formation;
determining a pattern correlation characteristic corresponding to the change characteristic;
determining a second gradation correction characteristic by performing an arithmetic operation on the first gradation correction characteristic and the pattern correlation characteristic; and
forming an image based on the second gradation correction characteristic.

13. The method of claim 12, comprising:
determining the pattern correlation characteristic based on a reference pattern correlation characteristic obtained by correlating the first gradation screen pattern with a second gradation screen pattern at the image formation.

14. The method of claim 13, comprising:
using the reference pattern correlation characteristic corresponding to the second gradation screen pattern.

15. The method of claim 12, comprising:
forming the image based on the first gradation correction function when the first gradation screen pattern is equal to the second gradation screen pattern.

16. The method of claim 12, comprising:
detecting a development bias value as the change characteristic.

17. The method of claim 12, comprising:
detecting the number of printed sheets as the change characteristic.

18. The method of claim 12, comprising:
detecting humidity as the change characteristic.

19. The method of claim 13, comprising:
correcting the reference pattern correlation characteristic based on a function indicating a shift amount of the reference pattern correlation characteristic with respect to a gradation level.

20. The method of claim 19, comprising:
correcting the reference pattern correlation characteristic based on a correction function obtained by performing an arithmetic operation on the function indicating the shift amount and a function to determine intensity of the function indicating the shift amount with respect to the change characteristic.
